(19) United States
(12) Patent Application Publication
(10) Pub. No.: US 2021/0089676 A1
(43) Pub. Date: Mar. 25, 2021

(54) METHODS AND SYSTEMS FOR SECURE DATA EXCHANGE

(71) Applicant: ECOLE POLYTECHNIQUE FÉDÉRALE DE LAUSANNE EPFL-TTO, Lausanne (CH)

(72) Inventors: Bryan FORD, Lausanne (CH); Linus GASSER, Echandens-Denges (CH); Eleftherios KOKORIS KOGIAS, Ecublens VD (CH); Philipp JOVANOVIC, Prilly (CH)

(21) Appl. No.: 16/970,611

(22) PCT Filed: Feb. 16, 2018
(86) PCT No.: PCT/EP2018/053886

§ 371 Date: Aug. 17, 2020

(51) Int. Cl. G06F 21/62; H04L 9/08; H04L 9/32; G06F 21/60

(52) U.S. Cl. CPC G06F 21/6227; H04L 9/085; H04L 9/3247; H04L 2209/38; H04L 9/0825; H04L 9/3218; G06F 21/604; H04L 9/3239

(57) ABSTRACT

The present invention concerns a computer-implemented method for secure data exchange between a sender (A) and a recipient (B), wherein the method is performed by the sender (A) and comprises encrypting data using a symmetric key k, creating a write transaction T_{W}, wherein the write transaction T_{W} comprises information usable to derive the symmetric key k and an access policy identifying the recipient (B) as being allowed to decrypt the encrypted data, providing the recipient (B) access to the encrypted data, and sending the write transaction T_{W} to a first group of servers (AC) for being stored in a blockchain data structure maintained by the first group of servers (AC).

### 1. TECHNICAL FIELD

The present invention generally relates to the field of secure digital data exchange, and more particularly to systems and methods for secure, decentralized, dynamic and/or accountable access control using blockchain technology.

### 2. THE PRIOR ART

In line with the prominent move to decentralization in digital data exchange, distributed ledger systems have become more and more popular. Distributed ledger technology may be understood by those skilled in the art as a consensus of replicated, shared and synchronized digital data that is geographically spread across multiple sites without a central administrator or centralized data storage.

One example of distributed ledger design is the blockchain system, which involves a continuously growing list of records called blocks, which are linked and secured using cryptography. For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority. Blockchains are secure by design and are an example of a distributed computing system with high Byzantine fault tolerance.

In fact, distributed ledger technology is considered a core building block for many next-generation technologies relevant in various sectors, such as finance [26], healthcare [25], e-democracy [16] and insurance [22]. For a proper functioning, however, these applications regularly postulate shared access to privacy-sensitive data between a multitude of independent, and potentially mutually distrustful, parties. Known solutions to private data sharing either forfeit access control or rely on a centralized service.

However, decentralization has not yet provided an alternative to such centralized access control services, as this would require ad-hoc knowledge of the recipients (i.e. their public keys) and also would forfeit the capabilities of auditing and revocation.

For example, one way of designing a decentralized data sharing application would require the sender to know the cryptographic keys (such as PGP keys) of the recipients and publish an encrypted copy for every one of them in a decentralized platform like Bitcoin [14] or Bittorent. Such publication means that the access control is enforced before the creation of the encrypted data and cannot be combined with on-the-fly logging or revocation. On another example, one could decouple the policies from the secrets making the access lists immutable on-chain, but entrust the data with a centralized off-blockchain storage service which holds the encryption keys and checks the on-blockchain access control policy before each access attempt. However, this re-introduces a single point of failure, as the logging and delivering of data is not atomic.

As an example, when a first computer user (referred to as “Alice” herein as is common in the field of cryptography) wants to send encrypted data to another computer user (“Bob”), one could employ a combination of PGP with Bitcoin's [14] blockchain which operates as follows: First, Alice encrypts the data using the PGP key of Bob and in order to guarantee that the data will be available when she goes offline, she posts the encrypted message on Bitcoin's blockchain. When Bob wants to read the data, he can download the correct block from Bitcoin's blockchain to retrieve the ciphertext and use his private PGP key to decrypt and read the data.

This, however, has at least two significant security restrictions: Firstly, upon the release of the encrypted data, Alice loses ownership of the data access policy. Even if she wants to revoke access and writes a revocation record to the blockchain, the ciphertext is already available encrypted to Bob's private key, which Bob can still use to decrypt the document. Hence, she is no longer able to withhold this data from Bob. Secondly, Alice is unaware of whether or not Bob tried to access and decrypt the data. Bob has plausible deniability in case of a privacy breach.

Moreover, the above design also falls short usability wise: Firstly, if the identity of Bob corresponds to multiple keys (e.g. per device key, or Bob is an organization with multiple employees), Alice will have to encrypt the message to each individual key. Secondly, if Bob wants to rotate his keys for security reasons, he has no longer access to the data, unless he requests Alice to re-encrypt.

Therefore, what is needed is a decentralized data sharing system and corresponding methods which support transparent, dynamic and/or accountable access control on privacy sensitive shared data within blockchain systems. More precisely, such a system should meet at least part of the following security objectives:
Auditable Decryption: Before an authorized user accesses secured data, there is an auditable proof logged.
Atomic Decryption: If a proof of accessing secured data is logged, the decrypted data (or corresponding key) are atomically delivered to the authorized user.
Dynamic Access Control: The data owner does not lose ownership over the data's access policy (as long as no-one auditably decrypts) and is able to request the data to be retained. The owner can also change the access rights dynamically to allow more decryptors.

In addition, such a system should also meet the following usability objectives at least in part:
User-Sovereign Identity: A user or organization is sovereign over his/its identity. The identity provider does not hold the keys of the user (unless requested) and hence is unable to impersonate the user.
Dynamic Identity Management: A user or organization is able to dynamically change his online-identity without losing access to any data. Furthermore, a user can revoke access rights of part of his identity (e.g. due to compromised keys).
Transparency: All actions are provable against a public log and clients can verify that the proofs they see have been disclosed, mitigating targeted equivocation attacks [15].

In view of the above, it is therefore the technical problem underlying the present invention to provide a decentralized data sharing system and corresponding methods that at least partly meet the above security and/or usability objectives and thereby at least in part overcome the above explained disadvantages of the prior art.

### 3. SUMMARY OF THE INVENTION

The invention is defined in the independent claims. Advantageous modifications of embodiments of the invention are defined in the dependent claims.

In one embodiment, the invention provides a computer-implemented method for secure data exchange between a sender and a recipient. The method may be performed by the sender and may comprise encrypting data using a symmetric key k. The method may further comprise creating a write transaction T_{W}, wherein the write transaction T_{W} comprises information usable to derive the symmetric key k and/or an access policy identifying the recipient as being allowed to decrypt the encrypted data. The method may further comprise providing the recipient access to the encrypted data. The method may further comprise sending the write transaction T_{W} to a first group of servers for being stored in a blockchain data structure maintained by the first group of servers. Advantageous modifications and additional optional features of the sender-side method are defined in the dependent claims.

The invention also provides a computer-implemented method for secure data exchange between a sender and a recipient, wherein the method is performed by the recipient. The method may comprise retrieving encrypted data, wherein the encrypted data comprises data encrypted using a symmetric key k. The method may further comprise retrieving a write transaction T_{W} from a blockchain data structure maintained by a first group of servers. The method may further comprise verifying the integrity of the write transaction T_{W}. If verifying the integrity of the write transaction T_{W} is successful, the method may further comprise sending a read transaction T_{R} to the first group of servers for being stored in the blockchain data structure maintained by the first group of servers. Advantageous modifications and additional optional features of the recipient-side method are defined in the dependent claims. Further, it will be appreciated that the method may comprise any functionality complementary to that of the sender-side methods.

The invention further provides a computer-implemented method for secure data exchange between a sender and a recipient, wherein the method is performed by at least one server within a first group of servers. The method may comprise receiving a write transaction T_{W} from the sender. The write transaction T_{W} may comprise information usable to derive a symmetric key k. The method may further comprise verifying the integrity of the information. If verifying the integrity of the information is successful, the method may further comprise storing the write transaction T_{W} in a blockchain data structure maintained by the first group of servers. Advantageous modifications and additional optional features of the server-side method are defined in the dependent claims. Further, it will be appreciated that the method may comprise any functionality complementary to that of the sender-side and/or recipient-side methods.

The invention further provides a computer-implemented method for secure data exchange between a sender and a recipient, wherein the method is performed by at least one server within a second group of servers. The method may comprise receiving a decryption request DecReq from the recipient. The decryption request DecReq may comprise a write transaction T_{W} and a corresponding read transaction T_{R}. The method may further comprise verifying the integrity of the read transaction T_{R}. If verifying the integrity of the transaction T_{R} is successful, the method may further comprise computing a decrypted share based on an encrypted cryptographic secret share associated with a cryptographic secret which is usable by the recipient to derive a symmetric key k, wherein the encrypted cryptographic secret share is comprised in the write transaction T_{W}. The method may further comprise sending the decrypted share to the recipient. Advantageous modifications and additional optional features of the server-side method are defined in the dependent claims. Further, it will be appreciated that the method may comprise any functionality complementary to that of the sender-side and/or recipient-side and/or server-side methods.

Furthermore, the present invention also concerns computer systems, apparatus, computer programs and non-transitory computer-readable media implementing any of the aforementioned methods.

Lastly, the invention further concerns a write transaction data structure and a read transaction data structure usable in the aforementioned methods and systems. To this end, the data structures may comprise any features complementary to the corresponding features of the aforementioned methods and systems.

### 4. SHORT DESCRIPTION OF THE DRAWINGS

In the following detailed description, presently preferred embodiments of the invention are further described with reference to the following figures:

FIG. 1: A schematic overview of a method for secure data exchange between a sender and a recipient in accordance with embodiments of the invention;

FIG. 2: A flowchart illustrating a one-time secret protocol in accordance with embodiments of the invention;

FIG. 3: A flowchart illustrating a long-term secret protocol in accordance with embodiments of the invention;

FIG. 4: A schematic diagram illustrating an exemplary path verification performed by a verifier for multi-signature requests in accordance with embodiments of the invention; and

FIG. 5: A schematic diagram illustrating an evolution of policies using skipchains in accordance with embodiments of the invention.

### 5. DETAILED DESCRIPTION OF PREFERRED EMBODIMENTS

In the following, presently preferred embodiments of the invention are described with respect to a system and method for secure digital data exchange also referred to herein as “SCARAB” (“Secret-Caring Blockchain”). Embodiments of the invention advantageously build upon blockchain technology and/or threshold cryptography to provide a secure and fully decentralized data-sharing system which supports transparent, dynamic and/or accountable access control on privacy sensitive shared data within blockchain systems, and/or auditability and/or atomic delivery of decryption requests.

Embodiments of the invention may thus be advantageously used to solve the following illustrative problem: A sender (“Alice”) wants to encrypt data (e.g. a document) for a recipient (“Bob”). However, Alice wants to preserve the capability of withholding the data later, and she wants to log the fact that it has been decrypted by some authorized user (e.g. to claim payment and/or Name in case of a privacy breach). At the same time, Bob wants to maintain the capability of dynamically changing his identity (e.g. his public keys) even after the data has been encrypted, but still be able to decrypt. Furthermore, Bob does not trust Alice to deliver the data, as she might try to log an access request and not serve the data, framing Bob in case of a privacy breach. Alice does not trust Bob either, as he might want to get the data in secret (e.g. if it was a simple PGP encryption) and claim that he never tried to decrypt. He will not leak decrypted data if the access is logged. As Alice and Bob are mutually distrustful, there is a need for a trusted third party, however, a single point of failure should also be avoided. It will be appreciated that the terms “sender”, “recipient” and equivalents thereof may be understood as referring to corresponding computer systems or to users of such computer systems, as will be apparent from the context.

To this end, embodiments of the invention may include all or a subset of the following aspects, which will be explained in more detail further below:

“On-chain secrets” (“OCS”), which may employ threshold cryptography and/or distributed ledger technology to enable a decentralized set of servers (also referred to herein as a “cothority”) to provide “secret-caring” services.

“Identity skipchain” (“IdS”), which comprises a blockchain data structure that enables both persons and federated groups to remain self-sovereign over their identities and/or dynamically evolve them. In certain embodiments, idSs are also used to express dynamically evolving access control policies.

Explanation of Basic Concepts

Before the above aspects of various embodiments of the invention will be described in more detail, the following is an explanation of basic concepts and notions that may serve as the foundation for certain aspects of the invention:

Cothority

The notion of a collective authority, or cothority, is introduced by Syta et al. [24], where they propose the decentralization of traditionally centralized Internet authorities such as CAs, randomness services [23], software update services [15], and even blockchain systems [10]. This trust-splitting increases the effort an attacker needs to do to compromise these services from one authority to a potentially large threshold of additional witnesses. As used herein, a “cothority” thus signifies a collectively trustworthy authority that enables fully decentralized data-sharing.

Scalable Witnessing—The first protocol supported by the cothority framework is Collective Signing [24]. CoSi's purpose is to enable a large group of witnesses to sign off on public-records, forcing the records' public disclosure before a client considers them valid. This increases the transparency of services such as Certificate Transparency [12]. CoSi achieves this by combining a tree-based communication pattern with an aggregatable signature scheme [17] that distributes the cost of transmission and cryptographic combination of the signatures to the full witness group.

Scalable Consensus—ByzCoin [10] builds on top of CoSi to create a scalable and secure blockchain supporting a cryptocurrency. Among its contribution is recognizing that CoSi does not implement consensus in case of leader failures. To address this challenge, ByzCoin builds a version of the PBFT [2] consensus algorithm on top of CoSi that manages to increase security and performance of Bitcoin-like cryptocurrencies. Subsequent work [11] make ByzCoin more robust by changing the communication pattern and more performant by pipelining the protocol's phases.

Skipchains—Chainiac [15] is a system for transparent software updates. One of Chainiac's contributions was extending ByzCoin's blockchain with multihop forward and backward skiplinks to enable efficient timeline traversal. This authenticated data structure is called “skipchain”, as it comprises a combination of skiplists and blockchains.

Threshold Cryptosystems

The following summarizes techniques for secret sharing and/or more general threshold cryptosystems that embodiments of the invention may build upon:

Secret Sharing—The notion of secret sharing was introduced independently by Blakely [1] and Shamir [20] in 1979. A (t,n)-secret sharing scheme, with 1≤t≤n, enables a dealer to share a secret a among n trustees such that any subset of t honest trustees can reconstruct a, whereas smaller subsets cannot. This means in other words that the sharing scheme can withstand up to t−1 malicious participants. In the case of Shamir's scheme, the dealer evaluates a degree t−1 polynomial s at positions i>o and each share s(i) is handed out to a trustee. The important observation here is that only if a threshold of t honest trustees works together, then the shared secret a=s(o) can be recovered through polynomial interpolation.

Public Verifiable Secret Sharing (PVSS)—PVSS [18] is a (t,n)-secret sharing scheme that allows a secret s to be shared among n participants, where any subset of t or more participants can recover the secret and any subset smaller than t cannot gain any information about s. The parameter t is also referred to herein as the PVSS threshold. PVSS enables third-party verifiability of secret shares without revealing any information on the shares or the secret. To achieve this property, PVSS uses non-interactive zero-knowledge (NIZK) proofs for equality of discrete logarithms [3, 4].

Distributed Key Generation (DKG) and Threshold Encryption—Once we are able to share one secret we can construct more complicated systems out of it. Certain embodiments of the invention use a DKG protocol [5] as well as a threshold encryption protocol [21]. The idea behind a DKG is to remove the trusted dealer from the secret sharing scheme by having one secret sharing round per trustee. Afterwards, the validity of the secret sharing protocol may be verified through acknowledgments of reception of valid shares. Once consensus is reached on the correctly shared secrets, each trustee can combine all his shares to a new share which corresponds to the distributed key. The advantage of this protocol is that nobody knows the distributed secret key and as a result the key can only be used if and only if a threshold of servers decide that using it is the correct thing to do. After generating the key, a client can encrypt data using the publicly shared key. One solution is to use Elgamal encryption, but this enables chosen ciphertext or malleability attacks. In order to provide a secure threshold encryption scheme, Shoup et al. [21] showed a way to bind the access control label with the ciphertext via NIZK proofs which may be used in certain embodiments of the invention and can be seen in Appendix A.

### General System Overview

The following is a general system overview relating to certain embodiments of the present invention.

System Model

Embodiments of the invention may implement, comprise and/or cooperate with one or multiple cothorities, which may be understood in their broadest sense as distributed groups of computer systems, in particular servers.

A first cothority is referred to herein as “access control cothority” (AC). The AC preferably maintains an access-log (preferably a blockchain data structure) which acts as a shared log of read and/or write requests. The log may be used to serialize requests (preferably all requests) and/or to transparently maintain proofs. It may be implemented using Skipchains [15] or OmniLedger [11] for higher performance.

The AC may also store the encrypted data to be exchanged among the users, preferably in its blockchain data structure. However, it is preferred that the AC stores only a hash of the encrypted data, while the actual data may be stored in a highly available centralized cloud storage, a decentralized distributed hash table (DHT), or more generally any other suitable storage medium. In any case, the AC may store symmetric keys in an encrypted form which are usable to encrypt and decrypt the data to be exchanged, as will be explained in more detail further below.

A second (logically separate) cothority is referred to herein as “secret caring cothority” (SC). The SC preferably manages one or more secrets. Depending on the type of secrets, there may be a different SC cothority per secret (OTS) or one SC cothority (LTS), as will be explained in more detail further below.

Depending on the implementation, both cothorities, i.e. the AC and SC, may be realized by means of the same or different servers.

Network Model

Preferred embodiments of the invention employ a public network such as the Internet for communication between the involved entities. As such, embodiments of the invention follow the network assumption of other cothority protocols [10, 23, 15], namely a weakly synchronous network with optimistic, exponentially increasing timeouts.

Threat Model

In a preferred embodiment, the security assumption of the AC is that at most ⅓ of the active cothority servers are malicious. The threshold of the VSS schemes on OCS cothorities (see further below) is generally a design parameter that trades-off availability with security. The threshold may be set to ⅓ for simplicity, since preferred embodiments employ the same server(s) to implement all cothorities.

As mentioned further above, readers typically do not trust writers to deliver the data, as the writers might try to log an access request and not serve the data, framing the readers in case of a privacy breach. Writers typically do not trust readers, as readers might want to get the data in secret (e.g. if it was a simple PGP encryption) and claim that they never tried to decrypt.

On-Chain Secrets (OCS)

As mentioned above, embodiments of the invention may use threshold cryptography [21, 7, 19, 5] to enable a user to encrypt data under the control of a group of semi-trustworthy servers [24]. The encryptor may encrypt the data for different recipients pinpointed with a minimally expressive (e.g. JSON) label on the access control policy. Any eligible decryptor may provide a proof of access against the policy of the data using his keys. Upon receiving this proof, the blockchain's managers (e.g. permissioned validators) may atomically log the proof and re-encrypt the data to the reader's public key in such a way that each read access is logged publicly and only the intended recipient can decrypt the data.

In other words, OCS enables data retention and/or auditable decryption in certain embodiments. As will be explained in more detail below, a sender may dispatch write transactions that encrypt the data “care of the cothority”, instead of directly to the recipient. If the recipient wants to decrypt, he may send a decryption request. If the sender wants to revoke the data, he may send a revocation request.

Certain embodiments of the invention may comprise or use two cothorities (which should be understood as logical groups of computers/servers, however, it will be appreciated that both cothorities may be implemented using the same computers, as already explained above): The “access control cothority” (AC) comprises a plurality of computer systems/servers which maintain a blockchain data structure. The blockchain data structure preferably logs encrypted secret shares, zero-knowledge proofs of encryption and/or access attempts. The “secret caring cothority” (SC) may be responsible for re-encrypting secrets to the authorized readers. Certain embodiments comprise ad-hoc, per secret SCs (see OTS below), or a well-defined single global SC (see LTS below).

As used herein, access policies may be encrypt-to-public-key policies, where the sender statically binds the secret with the recipient's public key. The recipient may sign its read transaction to request access and the AC may verify the signature before accepting the read transaction. In certain embodiments, this constraint is removed, however, and more complex policies, dynamically changing policies and/or identities may be defined (as will be explained further below).

In certain embodiments, the writer/sender (“Alice”) symmetrically encrypts the data under a key k, which represents a shared secret. The writer may store the encrypted data either on-chain or off-chain, but in either case, the reader/recipient (“Bob”) may retrieve the data and verify its integrity before making a decryption request.

Finally, certain embodiments of the invention provide a read and/or write transaction abstraction to store information on the blockchain. When a writer/sender wants to put a secret on the blockchain, it sends a write transaction to the AC, whereas the reader/recipient sends a read transaction requesting access to the encrypted data.

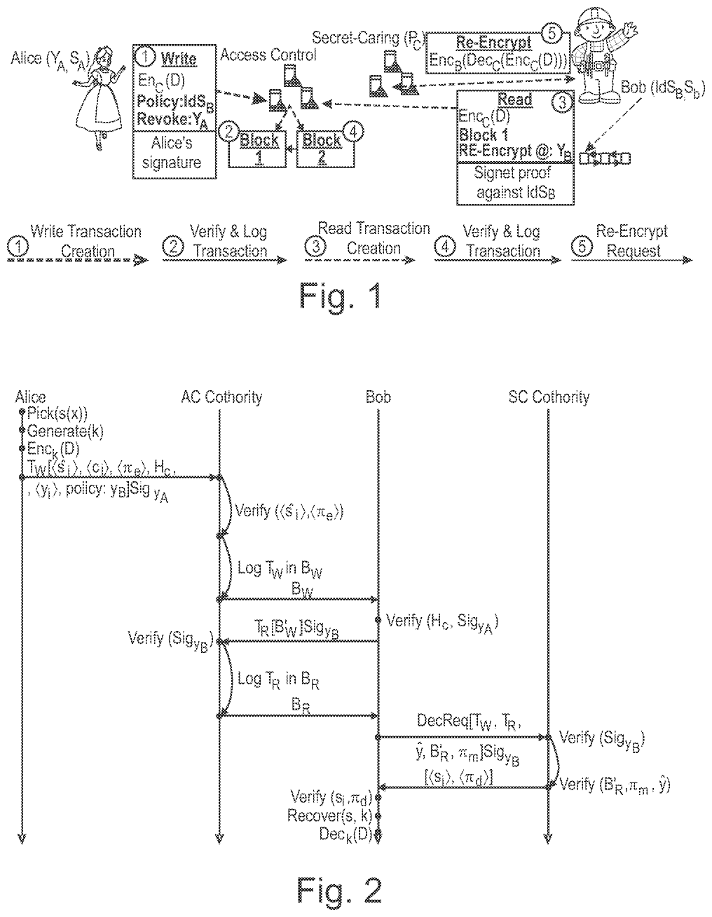

FIG. 1 illustrates a typical workflow: The writer/sender “Alice” encrypts the data “care-of” the SC, adding information identifying the reader/recipient “Bob” in the access control policy (in the depicted example, the information identifying the reader is its IdS, as will be explained in more detail further below). AC verifies and logs the transaction. Bob can prove ownership of the identity to AC which logs the proof. Finally, Bob sends the logged proofs to the SC, which re-encrypts the data to the public key provided by Bob. Note that FIG. 1 illustrates exemplary transactions in LTS, while OTS write transactions may additionally include the encrypted secret shares and/or the respective NIZK-proofs.

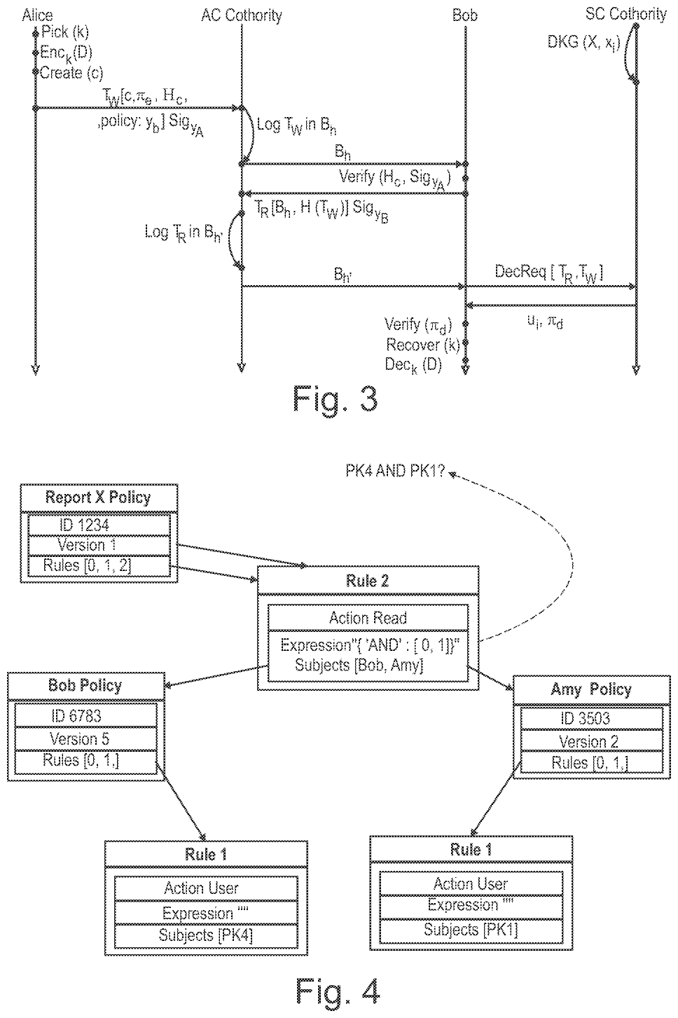

In the following, two alternative ways of implementing OCS according to embodiments of the invention will be described with reference to FIGS. 2 and 3, respectively:

One-Time Secrets (OTS)

FIG. 2 illustrates an OTS protocol according to an embodiment of the invention.

OTS is preferably implemented using Publicly Verifiable Secret Sharing (PVSS) [19]. This is a particularly simple way of implementing OCS, as it requires no state knowledge from the trustees. This simplicity is paid by higher encryption and decryption overhead, as will be explained in more detail further below.

OTS preferably employs one SC per secret. OTS's simplicity enables each write transaction to define a fresh, ad hoc group of servers that do not require any prior knowledge of or coordination with each other. This simplicity comes at a cost: both the write transaction size as well as the encryption/decryption overhead linearly increase with the size of the SC, i.e. its number of servers. This is because SC servers obtain the encrypted shares from the write transaction and there are as many shares as the number of servers in the SC.

Generally speaking, a sender A may initialize the OTS protocol by choosing a group of servers to act as trustees for holding A's secret. A may then perform PVSS [19] to create the encrypted shares for each server using their public keys. A may use the shared secret to generate the encryption key, may symmetrically encrypt the data under the encryption key, and may send a write transaction to the AC to be stored on the blockchain. Later on, the recipient B signs a read transaction and sends it to the AC. If AC verifies that B is authorized to access the data, B can show the proof-of-access to each trustee (SC server), together with the PVSS encrypted shares and obtain the decrypted shares that B can combine to reconstruct the symmetric key.

In more detail, the OTS protocol operates as follows in certain embodiments of the invention, as can be seen in FIG. 2:

Let [symbol] be a multiplicatively written cyclic group of large prime of order q with generator G, where the set of non-identity elements in [symbol] is denoted by [symbol] *. The sender A and the recipient B collectively trust a set of servers denoted by N={1, . . . , n}, which constitute the SC (e.g. A and B may negotiate the trusted set of servers offline). We denote the private key of each server i in the SC (SC trustee) with xᵢ and the corresponding public key by yᵢ=G^{x}^{ᵢ}. Similarly, we use (x_{A}, y_{A}) and (x_{B}, y_{B}) to denote A's and B's private and public keys, respectively. We also assume that the AC has an aggregate public key ŷ, which may be generated based on adding the AC servers' individual public keys together in ECC arithmetic and/or multiplying them in discrete-log integer groups, as it is common in the area of cryptographic signature schemes, such as Schnorr signatures. In the illustrated example, we require that t=└2|N|/3┘+1, which is the PVSS threshold as described above. Finally, we assume that all exchanged messages are signed by the sending party and verified by the receiving party.

In the following, various processing sequences performed by the sender A, the recipient B, the AC and the SC will be described in relation to certain embodiments of the invention and as illustrated in FIG. 2. It will be appreciated that the sequences may be performed independently from each other, as will be apparent to those skilled in the art.

Write transaction processing (writer A)

The sender A may create a write transaction T_{W} by executing the following steps or a subset thereof:
1. Map H(y_{B}) to a group element H∈ [symbol] *. In other words, a hash of the recipient B's public key (or more generally a hash of the information comprised in the access policy) may be mapped to a group element that may then be used as a fresh base independent from any other known base for use in the subsequent commitment H^{a}^{ⱼ} in step 3 below.
2. Choose a random polynomial s(x)=Σⱼ₌₀^{t-1}aⱼx^{j} of degree t−1. The shared secret becomes s=G^{s(o)}.
3. For each SC trustee, compute an encrypted share [symbol] =yᵢ⁽ⁱ⁾ of the shared secret s and create the corresponding NIZK encryption consistency proof πₑ, where 1≤i≤n. Create the polynomial commitments cⱼ=H^{a}^{ⱼ}, for o≤j<t. Note that instead of the NIZK proofs, any other suitable cryptographic encryption consistency proof may be used.
4. Calculate H(s) and use it as the symmetric key k to encrypt the message m. The encrypted message is c=Encₖ(m).
5. Create the write transaction:

T_{W}=[ [symbol] , [symbol] cⱼ [symbol] , [symbol] πₑ [symbol] ,H_{c}, [symbol] yᵢ [symbol] ,policy:y_{B}]sig_{y}_{_{A}}
where [symbol] is the list of encrypted shares, [symbol] cⱼ [symbol] is the list of polynomial commitments, [symbol] πₑ [symbol] is the list of NIZK-proofs, H_{c} is the hash of c, [symbol] yᵢ [symbol] is the public keys of the SC trustees, and policy is the public key of B to designate B as the decryptor of the cyphertext.
6. Send the write transaction T_{W} to AC. The sender A may send the write transaction to one server within AC and wait, wherein the server may propagate the transaction to the other AC servers. If the sender A does not receive a reply/confirmation within a predetermined timespan, the sender may re-try sending the write transaction to a different AC server.

When creating a write transaction, the writer A preferably derives the group element H from H (policy) to tie the PVSS commitments and proofs to the policy. Suppose an attacker obtains a write transaction from the blockchain, forges a transaction where she keeps everything except for the policy, which she changes with her public key, and dispatches it to AC. Since AC will derive a new H using the policy′, the PVSS proofs in the forged transaction will not verify against the new H. This way, OTS guarantees chosen-ciphertext attack (CCA) security.

Logging the Write Transaction (AC)

Upon receiving a write transaction T_{W} from a sender A, the AC may execute the following steps or a subset thereof (as explained above, there may be one server within AC which receives the write transaction and distributes it to the other AC servers. Preferably, each of the AC servers performs the following steps or a subset thereof):
1. Derive the group element H from H (policy).
2. Verify the integrity of each encrypted share ŝᵢ against the corresponding NIZK encryption consistency proof πₑ using the corresponding polynomial commitment the corresponding public key yᵢ and H.
3. If all shares are valid, log T_{W} to the blockchain maintained by the AC (note that the blockchain may be implemented as a skipchain, as will be explained further below).

Read transaction processing (reader B)

The recipient B may create a read transaction T_{R} by executing the following steps or a subset thereof:
1. Retrieve the encrypted data c either from the sender A, the AC or a suitable storage medium such as the above-mentioned cloud storage or decentralized distributed hash table (DHT). Retrieve the write transaction T_{W} from the AC, preferably from a blockchain block or skipchain block B_{W} comprising T_{W}. For example, the recipient B may identify the correct write transaction to retrieve based on a hash of the write transaction obtained from the sender A, and/or the recipient B may query the AC for any write transactions posted by the sender A any may then lookup the correct transaction.
2. Compute H′=H(c) and check if it matches H_{c} in T_{W}. Furthermore, the sender may verify that the write transaction has been included in a block of the blockchain/skipchain that is signed by the AC and/or may verify that the write transaction has been signed by the sender.
3. If the hashes match, create a read transaction:

T_{R}=[H_{W}]Sig_{y}_{_{B}}
where H_{W} is the hash of the write transaction.
4. Send the read transaction T_{R} to AC.

Logging the Read Transaction (AC)

Upon receiving a read transaction T_{R} from a recipient B, the AC may execute the following steps or a subset thereof (as already explained above, each AC server may perform the steps individually):
1. Use y_{B} in T_{W} to verify the signature of T_{R}. Note that the AC may identify the write transaction T_{W} corresponding to the received read transaction T_{R} based on the Hash H_{W} of the write transaction T_{W} which is comprised in the read transaction T_{R}.
2. If the signature is valid, log T_{R} to the blockchain maintained by the AC (note that the blockchain may be implemented as a skipchain, as will be explained further below). The logging of T_{R} may be implemented similar to logging write transactions T_{W}, as explained further above.

Decryption Request (Reader B)

To obtain the decrypted shares of the secret, the recipient B may send a decryption request to each SC trustee, which may comprise the following steps or a subset thereof:
1. Create a decryption request:

DecReq=[T_{W},T_{R},B′_{R},ŷ,πₘ]Sig_{y}_{_{B}}
where T_{W} is the write transaction, T_{R} is the read transaction (note that the actual decryption request may include a reference to these transactions, e.g. by means of a unique identifier or hash), B′_{R} is the signed header of the block that stores T_{R}, ŷ is the aggregate public key of the AC (as explained above), and πₘ is the Merkle path to prove the membership of T_{R} in the blockchain or skipchain maintained by the AC. Note that B′_{R} ensures that the read transaction T_{R} is actually stored in the blockchain data structure of the AC (preferably, B′_{R} is signed by the AC and there may be a proof against B′_{R} that T_{R} is part of it), and any other suitable information to identify this fact may be used instead of B′_{R}.
2. Send DecReq to the trustees in SC (similar to what was explained above, the recipient may send the decryption request to one trustee, wait and retry with another trustee in case he does not receive a confirmation).

Decrypting the Shares (SC Trustee)

Upon receiving a decryption request DecReq from the recipient B, each SC trustee may execute the following steps or a subset thereof:
1. Use y_{B} in T_{W} to verify the signature of T_{R}.
2. Verify that T_{R} is logged in the blockchain or skipchain of AC using πm, ŷ and the Merkle root in KR.
3. Compute the decrypted share sᵢ=( [symbol] )^{x}^{ᵢ}^{^{−}} and/or create the corresponding NIZK decryption consistency proof π_{d}.
4. Send the decrypted share sᵢ and/or the decryption consistency proof π_{d} back to the recipient B, preferably using a private communication channel.

Key Reconstruction (Reader B)

To reconstruct the shared secret s and then the symmetric key k, the recipient B may execute the following steps or a subset thereof:
1. Verify each decrypted share sᵢ against the corresponding decryption consistency proof π_{d}.
2. Discard the invalid shares. If there are at least t valid decrypted shares, recover s, preferably by performing Lagrange interpolation.
3. Recover the symmetric encryption key k by computing H(s).
4. Using k, decrypt the encrypted data c to obtain the original data m=Decₖ(c).

### Evaluation of One-Time Secrets (OTS)

As explained above, OTS is one way of implementing OCS in accordance with an embodiment of the invention. An advantage is that OTS does not need any bootstrapping phase and it enables the sender A to use a different set of trusted servers in SC for each secret without requiring the servers to keep any protocol state. This makes the protocol simple to implement and reason about.

On the other hand, OTS has several shortcomings:
1. High verification cost: The recipient B needs to verify all n encrypted shares after retrieving them from the AC. Moreover, the recipient B needs to verify at least t shares upon a decryption request.
2. High reconstruction cost: In order to reconstruct the secret, the recipient B needs to perform Lagrange interpolation (or another suitable method to combine the shares) locally. For large numbers of shares, it may become a computationally expensive process on the client device associated with the recipient B.
3. High encryption cost: The sender A needs to generate n shares and NIZK-proofs. For large numbers of shares, it will become a computationally expensive process on the client device associated with the sender A.
4. Large transaction size: Since a write transaction contains the encrypted shares and NIZK-proofs for each server in the SC, increasing the number of servers will make the transaction larger.
5. Post-hoc key creation: The sender A cannot use OTS to share an already existing encryption key, but has to either re-encrypt the data or use another key that encrypts the original key.

### Long-Term Secrets (LTS)

FIG. 3 illustrates an LTS protocol according to an embodiment of the invention.

LTS is preferably implemented using Distributed Key Generation (DKG) and/or Verifiable Secret Sharing (VSS) [21] primitives. In the preferred embodiment of LTS, there is a dedicated group of servers (SC) which is preferably aware of participating in the system. In certain embodiments, LTS requires a bootstrap phase (e.g. implemented using DKG) so that the SC trustees remember their state (e.g. represented by their VSS secret shares). On the other hand, LTS has a constant encryption/decryption overhead and/or a constant write transaction size. In certain embodiments, the overhead of encrypting/decrypting secrets is constant because all write transactions use the shared key of the SC and thus, there is no need to publish the shares (as in OTS).

Furthermore, in certain embodiments LTS supports further functionalities such as reconfiguration of the trusted servers (“trustees”) in the server group SC and/or delegation of “secret-caring” services to other trustees and/or a different server group SC.

In the following, various processing sequences performed by the sender A, the recipient B, the AC and the SC will be described in relation to certain embodiments of the invention and as illustrated in FIG. 3. It will be appreciated that the sequences may be performed independently from each other, as will be apparent to those skilled in the art.

Distributed Key Generation

Unlike the OTS embodiment (see above), embodiments of the invention based on LTS may comprise a bootstrapping phase performed by the servers of SC, wherein the bootstrapping phase preferably uses a Distributed Key Generation (DKG) protocol. The basic idea in DKG is that a distributed set of servers collectively generates a private/public key pair in a way that the private key is not known to any single party, but can be reconstructed by a threshold t+1 of available key shares. Each server holds one such share and if t+1 shares collaborate, they can reconstruct this key to sign and/or encrypt/decrypt data.

Embodiments of the invention may employ any known DKG protocol, such as HybridDKG [8]. However, given how rare the event of key generation is, a very pessimistic synchrony assumption for the DKG (e.g. Δ=1 minute) can be assumed and the DKG protocol is preferably implemented based on the protocol disclosed in Gennaro et al [5] because of its simplicity and the fact that it produces uniformly random keys.

More formally, Let N={1, . . . , n} denote the list of servers that participate in SC and that n=3f+1 where f denotes the number of dishonest servers. Further, let t be the reconstruction threshold such that t=f+1 (as we are preferably in synchronous mode, we can assume up to t=2f+1 for more safety). We make the standard assumptions of using g to denote a generator of a secure subgroup [symbol] . After the DKG is executed, the output is a public key X=g^{x}, where x is the private key that is unknown. Additionally, each server i holds a share of the secret share denoted as xᵢ and all servers know the public counterpart Xᵢ=g^{x}^{ᵢ}.

Write Transaction Processing (Writer A)

The sender A may execute the following steps or a subset thereof:
1. Cothority key retrieval: The sender A may obtain the public key X of the SC. The key X is preferably available from the blockchain data structure maintained by AC, e.g. in a genesis block thereof. Alternatively, more dynamic key evolution techniques may be employed, as e.g. disclosed in Chainiac [15].
2. Symmetric encryption: The sender A may pick a key k (e.g. randomly) to symmetrically encrypt the data and may then embed the key k to a point m∈G. In other words, the method preferably uses ElGamal encryption or another suitable elliptic-curve cryptography method. The key k is preferably a random number and what is needed is a point (x,y) on the curve. To this end, the method may brute force a point where x=r and y is random such that the point is part of the curve.
3. Cyphertext generation: The sender A may use ElGamal encryption modified for threshold cryptosystems [21] to share the secret with SC. More specifically, the sender A may pick a random number r and compute c=(X^{r}m,g^{r}), where m is the secret, X is the shared public key, r is a blinding factor, and g^{r} is the public part of the blinding factor in accordance with conventional ElGamal encryption. The sender may also create corresponding encryption consistency proofs, preferably NIZK proofs, πₑ to guarantee that the system is chosen cyphertext secure and non-malleale. Exemplary NIZK proofs are illustrated in Appendix A further below. Finally, the sender A may define a policy L which includes the public key y_{B} of the recipient B.
4. Write transaction creation: The sender A may create a write transaction T_{W} which contains c, πₑ, a hash H_{c} of the symmetrically encrypted data and/or the policy. The sender A may sign the transaction using its private key x_{A}.
5. The sender A may send the write transaction T_{W} to AC for logging in a similar fashion as in OTS described further above.

Logging the Write Transaction (AC)

The logging may be similar to the OTS alternative described further above, with the exception that there are no encrypted shares, but only encryption consistency proofs of correct encryption under the shared public key X.

Read Transaction Processing (Reader B)

The recipient B may create a read transaction T_{R} by executing the following steps or a subset thereof:
1. Encrypted data retrieval (reader B): The recipient B may request the block with the sender A's write transaction T_{W} (e.g. identified by the block number and transaction hash) and may perform the following:
1a. Verify the sender A's signature and/or πₑ; Furthermore, the method may verify that the encrypted data verifies against the hash in the write transaction; and if successful
1b. Store the encrypted data to ensure availability upon decryption.
2. Read transaction creation (reader B): The recipient B may create a read transaction T_{R} pointing to the write transaction T_{W} (e.g. by using the block header Bₕ and the hash of T_{W}) and may sign the transaction T_{R} with his private key x_{B} as proof of access.
3. The recipient B may send the read transaction T_{R} to AC.
4. Read transaction validation (AC): The AC may verify the signature of the read transaction T_{R} using the public key in the policy of the write transaction T_{W}, and upon success may log the read transaction T_{R}. This is preferably done in a manner identical to the OTS embodiment described further above.
5. Collective re-encryption (reader B, SC): The recipient B may collect the logged read and write transactions from the AC. Then, the recipient B may either go to each SC server i and collect the encrypted share uᵢ=g^{rx}^{ᵢ}, or may delegate the reconstruction to a server he trusts not to DoS him. Both alternatives will be described in the following:

Secret retrieval (reader B)
1. Share Verification: For each share uᵢ, the recipient B may verify the decryption share creation NIZK proof π_{d} (see Appendix A further below) until the recipient B has collected t valid shares, with t being a predefined reconstruction threshold.
2. Combining shares: Assuming that the recipient B has a set oft decryption shares (i,uᵢ), the recovery algorithm may comprise performing Lagrange interpolation of the shares:

$${X}^{r} = {\prod }_{k = 0}^{t} {u}_{i}^{{λ}_{i}}$$

where λᵢ is the i^{th} Lagrange element.
3. Decrypt: The recipient B may compute the inverse of X^{r} and finds m=cX^{-r}. From m, the recipient B can derive the symmetric key k and may symmetrically decrypt the original data.

Collective Re-Encryption

If the recipient B is e.g. retrieving the data with a portable or IoT device, it may be preferable that the recipient B does not have to do the costly public key operations as explained above. The recipient B may thus use a protocol that enables any untrusted server to do the share reconstruction on behalf of the recipient B.

We assume that this server is honest-but-curious and will not DoS the recipient B, but wants to see the decryption. The recipient B selects a server to do the share reconstruction instead of him. He signs this delegation request with y_{B}=g^{x}^{_{B}}.
1. ElGamal Re-encryption: Each SC server that created its decryption share as g^{rx}^{ᵢ}=uᵢ ElGamal encrypts the share for the recipient B using xᵢ as a blinding factor instead of a random r′. The new share becomes
   g^{rx}^{ᵢ}g^{x}^{_{B}}^{x}^{ᵢ}=g^{(r+x}^{_{B}}^{)x}^{ᵢ}=g^{r′x}^{ᵢ}=u^{r′x}^{ᵢ}=u′ᵢ. Then, the server computes the NIZK proofs π_{d} as described above to show that the share has been correctly generated (see Appendix A further below).
2. Share combination: The untrusted server operating on behalf of the recipient B collects t valid shares and reconstructs the re-encrypted secret with Lagrange interpolation as explained above. The end result would be g^{r′x}=g^{(r+x}^{_{B}}^{)x}. Note that the server never sees g^{rx}, and therefore learns nothing.
3. Secret retrieval: The recipient B gets g^{(r+x}^{_{B}}^{)x} and as he knows g^{x} and x_{B}, he can find −x_{B} and compute g^{x}^{^{−x}}^{B}=g^{-xx}^{_{B}}. Finally, the recipient B can compute g^{rx}=g^{(r+x}^{_{B}}^{-x}^{_{B}}^{)x} and can carry out the decryption as explained further above.

Evolution of the Secret-Caring Cothority

Given that the SC is comparatively long-lived in LTS, embodiments of the invention may provide measures to make sure that it remains secure and/or available. A number of issues may arise during the lifetime of the system of embodiments of the invention. Firstly, secret-holding servers may join and/or leave, introducing churn in the SC. Secondly, even if SC memberships are static, private shares of the secret-holding servers should be refreshed and/or rotated regularly (such as every month), so that an attacker cannot collect a threshold of shares over a sufficiently long time. Finally, for security reasons it is also preferred that the shared public/private key pair of the SC is rotated (e.g. once every year or two). This will require re-encrypting the long-lived secrets from one shared keypair to another.

The first two problems can be solved by periodically re-sharing [6] the existing collective public key when a secret-holding server joins and/or leaves the SC and/or when the server wants to rotate its individual private key-shares. For the last challenge, where the SC wants to rotate the shared public/private key pair (X,x), embodiments of the invention may collectively re-encrypt each individual valid secret under the new public key Y=g^{y}. To achieve this, embodiments of the invention may generate translation certificates [7].

On a high level, the functionality of the collective re-encryption may be performed as follows: Let c₁=(mg^{rx},g^{r}) be an ElGamal encryption of a message m with respect to a public key X, and let x be the corresponding secret key, which is shared by the trusted servers using a threshold scheme as described before. The trusted servers want to compute the ElGamal encryption c₂=(mg^{yt},g^{t}) of m with respect to the public key Y. However, they do not want to expose m to any set of dishonest servers (or any other set of servers). Furthermore, they do not know the private key y, corresponding to Y. To translate c₁ to c₂, embodiments of the invention may perform the following two steps:
1. Trustee i selects a value tᵢ uniformly at random ∈ [symbol] _{q}, and computes (aᵢ,bᵢ)=(g^{-rx}^{ᵢ}g^{yt}^{ᵢ}, g^{t}^{ᵢ}), which is referred to as the translation share.
2. The SC servers (or an untrusted gateway) collect a threshold of shares and compute the translation (c₂,g^{t})=(c₁πₖ₌₀^{t}aₖ, πₖ₌₀^{t}bₖ).

The above algorithm is not robust on its own, nevertheless the trustees distributively generate robust translation certificates, using the protocol introduced by Jakobsson et al [7] to guarantee that they performed the translation correctly. Afterwards the translation certificate is appended to the (re)write transaction of the secret on the blockchain for Bob to verify before issuing a read request.

Periodically creating fresh secret-holding keys and collectively re-encrypting all secrets in the currently-outstanding state from the old (X) to the new (Y) shared public keys is a per-object operation. This means that it can take a long time in a large system holding many secrets, hence it should be done rarely and through a long period of time where both X and Y are considered valid.

Relationship Obfuscation in OCS

One challenge of certain embodiments of the OCS design is relationship privacy. Once the sender A indicates that the recipient B should be able to decrypt the write transaction, it becomes evident and logged on the blockchain that A and B have some kind of relationship.

One step towards better privacy is to hide the actual blockchain from the public and only let the cothority view it and serve read and write transactions as described above. However, given the adversarial model of the cothority, this does not solve the problem as the adversary may be inside the cothority and as a result has to view the transactions in order to validate them.

To solve this problem, certain embodiments of the invention may employ an “on-chain private key exchange” protocol. The basic idea of the protocol is that the sender A will hide the recipient B's identity in the write transaction, while generating a temporary public key for the recipient B to use in his read transaction. The corresponding private key can only be calculated by the recipient B, and a signature from this corresponding private key is enough for the sender A to prove that the recipient B did create the read transaction. The protocol may comprise the following steps:
1. Key generation: The sender A may generate a random number r and may use it to generate the recipient B's temporary public key y′_{B} as y′_{B}=y^{r}_{B}=g^{rx}^{_{B}}.
2. Write transaction creation: The sender A may use y′B instead of y_{B} in the policy of the write transaction. In order for the recipient B to be able to calculate x′_{B}=x_{B}r he needs r. The sender A may encrypt r for the recipient B in the write transaction. The sender A may pick a random number r′ and may encrypt r as e=g^{x}^{_{B}}^{r′}r and f=g^{r′}. The final write transaction has y′_{B} as the allowed reader and e₁f as further metadata of the ciphertext.
3. Read transaction creation: When the recipient B wants to read, he will first decrypt e by computing f=f^{x}^{_{B}} and then

$$r = \frac{e}{{f}^{′}} .$$

Then he will compute x′_{B}=rb (where b is x_{B}) and use it to sign the read transaction.
4. Auditing: If the sender A wants to prove that the recipient B generated the transaction, the sender A can simply release r. Then, anyone can verify that y_{B}=y′_{B}g^{-r} and as a result be sure that only the recipient B could know x′_{B}.

### Dynamic Identity Management and Access Control

As explained further above, one aspect of embodiments of the invention relates to enabling users to remain self-sovereign over their identities and/or dynamically evolve them, as well as expressing dynamically evolving access control policies.

To this end, embodiments of the invention may provide skipchains for dynamic access control. A skipchain [15] is a specific type of blockchain data structure which comprises signed forward links [9] to delegate trust. Certain embodiments of the invention use this data structure for identity management and/or to enable flexible and/or dynamic access-control, so that anyone can follow the identity of a user and/or organization through time without trusting centralized look-up services. This personal blockchain creates a digital identity for the user who can now use it to include multiple aspects of his digital presence, such as his SSH and/or PGP keys, and enables external clients to track reliably and securely the authoritative set of keys of the user.

The so-called “identity skipchain” (IdS) may also be used to create a federated identity of a ministry, corporation, or other multi-user entity. Such an IdS may point to other personal IdSs that can have variable access levels and/or can be managed in a decentralized fashion. At the same time the users are free to evolve their personal identity, adding and/or removing keys, without gaining any more privileges. Revoking an employee's access is as easy as excluding the employee's IdS from the corporation's IdS.

Finally, the same federated IdS may be used for defining dynamically evolving access control policies which, may be expressed in a minimal JSON-based language.

In other words, IdS may enable a recipient B to manage his identity, while preserving a provable trust delegating path to his new keys. A sender A may now encrypt data to the identity of the recipient B, who can receive the decrypted data anytime, by authenticating to the cothority. Similarly, the sender A can generate a policy IdS for the data that dynamically changes by adding and/or revoking access rights, without having to encrypt the data more than once.

With regard to the dynamic evolution of the access control as provided by certain embodiments of the invention, two use cases may be differentiated:
a. The sender A encrypts its data and posts a write transaction, but later decides to share the data with more recipients, i.e. decryptors (e.g. medical data sharing with a new hospital).
b. The recipient B decides to change its public keys, e.g. for security purposes, or the recipient B may be an organization that evolves over time.

In certain embodiments, every such change would result in the creation of a new write transaction as well as the revocation of the previous write transaction. In the following, it will be shown how to create decentralized dynamic identities and/or policies to gracefully handle the identity evolution and/or access control. We denote the fact that an identity is in fact a policy of a set of public keys that can authorize actions by signing requests, however, we specifically define identities due to its distinct representation of a natural or legal person.

### Identity Skipchains

Embodiments of the invention may employ a data structure referred to herein as “Identity Skipchain” (IdS), which may be used on a per-user basis and/or for federated identities, as will be explained in the following.

### Personal Identity Skipchain

The Identity Blockchain was first introduced in a workshop talk [9] as part of a decentralized SSH key management protocol. We briefly reiterate the main design points for the sake of design completeness. This basic data structure was later adopted by Nikitin et al [15] and enhanced with skiplinks to create Skipchains. We adopt this enhancements in embodiments of the present invention and refer to the combination as IdS.

We define the per-user IdS that enables the user to access services (e.g. OCS-Service) from multiple devices without the need to manually configure the remote locations every time a key changes. The IdS preferably comprises blocks storing two types of keys. The first type are the cold keys of the user (ideally stored offline in multiple devices) which are used only when the user evolves his identity. The second type are the warm keys that are used for the applications that the user wants (e.g. sh keys, pgp key). The warm keys can be optionally encrypted under a symmetric key for users that want their identity to only be followed by other users they know and have shared the symmetric key with.

One of the basic differences between the use of blockchains for identity management is that they need to enable trust-delegation so that the identity of the user can evolve over time. For this reason we use doubly-linked blockchains [9, 15] in certain embodiments. Backward links are cryptographic hashes like normal blockchains; Future blocks, however, do not exist at the time of block creation, thus forward links cannot be cryptographic hashes incorporated into the parental block. To enable the secure creation of forward links, digital multi-signatures may be used. When a block is created, a threshold of cold keys (included in different devices ideally) signs the block thereby creating a forward link from the current to the new block. This way, the user delegates trust from the old set of keys to the new ones and a client following the chain can easily verify each step, without depending on an intermediary. To enhance security against compromise of deprecated cold keys, the AC Cothority may be used to timestamp any new identity block and enforce a single-inheritance rule (no-forks).

Federated Identity Skipchain

When dealing with groups of users within an organization, defining the identity of the organization by adding all the keys and updates of employees to one shared IdS would quickly lead to a big number of conflicts, as multiple people concurrently try to change the IdS. For this reason, embodiments of the invention may employ recursive federated IdSs.

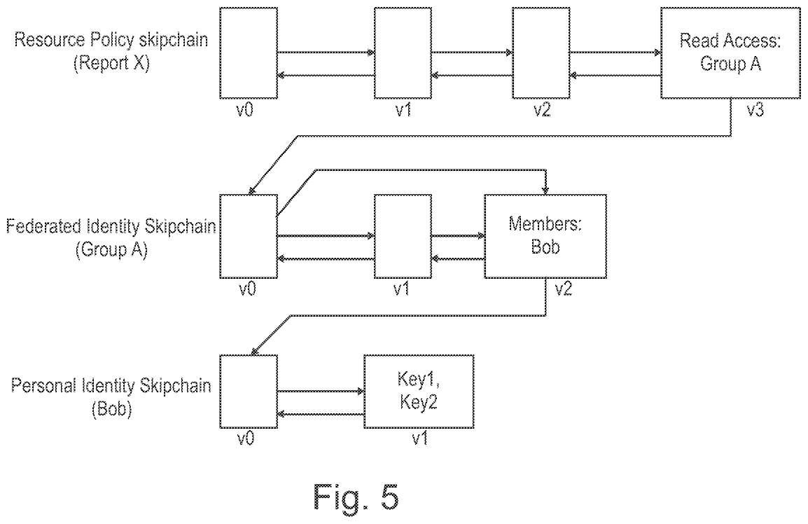

As illustrated in FIG. 5, the federated IdS does not only comprise public keys, but also personal IdSs of the employees (e.g. Bob in the example of FIG. 5). This way, a user can manage his identity independently and re-use it at multiple locations. Also revocation becomes cleaner, as removing an employee's IdS from the federated IdS automatically removes the employee's ability to create inclusion proofs against the federations' IdS.

Access Control Policies

The above-explained concepts of federated IdSs may be extended to policy skipchains in certain embodiments of the invention. The basic intuition is that the same way federated identities evolve (to include and/or exclude authorized users) can be used to define access control rules.

Thus, using federated identities (or policy identities) may enable the sender A to dynamically change the access writes of a specific document. Instead of using the IdS of the recipient B or of the recipient's organization in the access control policy, the sender A may create a new IdS specific for the document. The sender A may then manage this IdS dynamically the same way as any other federated identity.

For example, the sender A may create a policy skipchain PolS for its medical records and then share it dynamically with its new doctor or a hospital in Brazil, where the sender A had to pay an emergency visit. This enables the sender A to always be sovereign over its data. Finally, the expressiveness of PolSs may be enhanced by defining access control rules that enable the sender A to have multiple rules and/or rules with more complex conditions attached to the write transaction.

A policy is a set of rules that regulates access control to a resource. Preferred embodiments of the invention use a simple JSON-based access control language to express policies. In the following, the policy structure of certain preferred embodiments will be explained in more detail it will be described how requests for access to resources are created and/or verified.

Policy Structure

This section describes the structure of policies of an embodiment of the invention and demonstrates how they can be used to provide access control.

A policy may comprise a random ID, a version number and/or a list of rules that outline the access control. A rule may comprise an “Action” and “Subjects”. “Action” refers to the type of activity that can be performed on the resource (e.g. encrypted document). It may be an application-specific string indicating the activity. “Subjects” may be a list of users that are allowed to perform an “Action”.

To permit both individuals and federations to be Subjects similar to federated IdSs, a Subject may either be a public key or an IdS.

To build more sophisticated rules, we introduce the concept of Expressions. An Expression is a string of the form: {operator: [operands]}. Operator may be a logical operator (such as AND/OR/NOT) and operands may be a list of Subjects. An example would be:

{AND: [IDGroup₁; IDBob]}.

In the context of signatures, this means that both IDGroup₁'s and IDBob's signatures are required by a particular rule. Expressions may be combined to express more complex conditions for rules. For example, the expression:

{‘OR’: [{‘AND’: [S₁; S₂]}, {‘AND’: [S₃; S₄]}]}

evaluates to ((S₁ AND S₂) OR (S₃ AND S₄)).

Access Requests and Verification

This section outlines how requests to access a resource may be created and/or verified. A request may comprise information about the access policy that allows the action the requester wants to perform. Hence, a request may comprise the policy and the specific rule invoked.

In addition to this, there may be additional information required to complete a request. For example, a set of documents might be governed by the same policy but the requester might require access to a specific document. The request structure of certain embodiments of the invention also comprises a message field where extra information can be provided.

A request Req may have the form:

Reg_{Req}=[ID_{policy},Index_{Rule},M],

where ID_{Policy} is an ID of the target policy outlining the access rule(s), Index_{Rule} is an index of the rule specifying the access required by the requester and M is a message describing extra information relevant to the request.

To have accountability and verify that the requester is allowed to access the resource, signatures may be used. The requester may sign the request with his key and may create a signature comprising the signed message and the public key used.

A request signature Sig_{Req} may have the form:

Sig_{Req}=[R,PK],

where R is the Req signed with the requester's signing key and PK is the requester's corresponding public key.

An access request may comprise the request and the signature:

(Req,Sig_{Req})

On receiving an access request, the verifier may check that the R is present and correct. The verifier may then check that there is a valid path from the target policy, ID_{Policy}, to the requester's public key, PK. This may involve multiple levels of checks, if the requester's key is not present directly in the list of subjects but is included transitively in some federated IdS that is a subject. The verifier may search along all paths until the requester's key is found.

Sometimes, an access request may require multiple parties to sign off. Conditions for multi-signature approval may be described using the Expression field in the rules, as described in the previous section. An access request in this case would be of the form

(Req,[Sig_{Req}]),

where [Sig_{Req}] is a list of signatures from the parties that are required for the access. The verification process may be similar to the single signature case.

FIG. 4 illustrates an example of the path verification performed by the verifier. In the example, Report X has a policy with a Rule granting read access to Bob and Amy. There is an expression stating that both Bob's an Amy's signatures are required to obtain access. Hence, if Bob wants to access, he sends a request

(Req,[Sig_{Req,Bob},Sig_{Req,Amy}]),

where Req=[1234,2,“ReportX”], Sig_{Req,Bob}=[R_{SK}_{₄},PK₄] and Sig_{Req,Amy}=[R_{SK}_{₁},PK₁].

The verifier checks the paths from the policy to Bob's PK₄ and Amy's PK₁. Then the expression AND: [0,1] is checked against the signatures. If all checks pass, the request is considered to be verified.

Evolving Policies and Combining with Identities

Preferred embodiments of the invention use access requests to update policies. In this context, an update to a policy refers to a change in its rule set. An update to a policy preferably results in an increment in its version number. In order to maintain a verified record of all policy updates, the same structure as IdSs may be used. Thus, each policy may create its own policy skipchain (PolS) and updates to a policy result in the creation of a new block.

FIG. 5 illustrates an example where Report X has a PolS, group A is a federation with its own federated IdS and Bob is part of A but also manages his personal IdS. The latest version of the PolS grants read access to Group A, of which Bob is a member. Bob can access Report X since he is a member of the group that has access. If a new version of the policy (v₃ in the example) is created where Group A does not have access, its members will no longer be able to read the document.

In case of an access request from Bob's Key₁ to Report X's policy, the path is shown in FIG. 5. The rules in the latest policy skipblock indicate which skipchain to access. The skiplinks allow for fast traversal through the versions of the policy.

### SUMMARY

In summary, the preferred embodiment of the invention can be considered the first blockchain system that provides secure, decentralized and dynamic access control where accesses to sensitive data are transparently logged. It provides knowledge of accesses even during revocation events, so that audibility and blame accreditation is guaranteed, in case of privacy breaches. In the preferred embodiment, the system introduces two functionalities to enable its goals. The first is on-chain secrets, a novel capability for blockchain systems that uses verifiable secret sharing to collectively manage encrypted data under a Byzantine adversary. The second is the identity blockchain (IdS), which uses a skipchain data structure to securely establish and dynamically manage personal or federated digital identities and to define dynamic access control policies. Apparently, both functionalities may be provided independently in certain embodiments of the invention.

This way, embodiments of the invention minimize information leakage, where it is crucial to store on-chain data in a protected way such that a data provider does not need to know the keys of all potential future recipients, and which additionally allows on-the-fly access logging and revocation. In order to produce a data sharing platform exhibiting the above properties, embodiments of the invention address two fundamental challenges: Firstly, how to share data in a Byzantine adversary model, where a subset of the trusted data holders can try to collude and decrypt the data or attempt to launch Denial of Service attacks on the platform and secondly, how to define access control rules such that user identities can change dynamically, while the data remains accessible only to the authorized users (i.e. update and revoke keys).

Security Considerations

The following is an overview of how embodiments of the invention achieve the objectives introduced in the introductory portion and throughout the present patent application:

Auditable Decryption

To guarantee auditable decryption we need to guarantee privacy of encrypted data and auditability of accesses:

Privacy of Secrets: No secret is revealed to an unauthorized reader.

OTS: OTS remains private due to the privacy of PVSS as long as the assumption that less than t of the trustees collude. AC can verify the encrypted shares without obtaining any information about the shares. All decrypted shares are sent to the reader using a private channel.

LTS: LTS remains private due to the unpredictability of the DKG algorithm, which guarantees that the shared private key is never revealed, as long as less than t of the cothority servers collude. All shares are encrypted under y_{B} and remain private during reconstruction.

Auditability of Accesses: No secret is revealed unless auditable proof is stored and available to the writer.

Any read transaction is validated by the cothority and serialized on the blockchain, before the cothority re-encrypts the secret (LTS) or the reader has enough proof to request decrypted shares (OTS).

Atomic Decryption

To guarantee atomic decryption we need to guarantee data availability to the reader and atomic delivery of encryption keys.

Data Availability: The reader will hold a valid copy of the encrypted data before creating his read transaction (auditable proof).

The write transaction holds a hash of the encrypted data, so that the reader can be sure that the copy he retrieved from an untrusted highly available storage is valid. Only after verification does the reader create a read transaction.

Atomic Delivery: If a proof is being logged then the re-encryption key will be delivered.

Given correct AC and SC cothorities (less than f Byzantine servers) and a partially synchronous network, the cothorities will either execute both (a) the read transaction logging and (b) the key re-encryption or reject (a) and stop.

Dynamic Access Control

The writer is able to dynamically change the access control of the data by extending the collective IdS that was bound to the encrypted data during the write request creation. Adding new IdS pointers corresponds to new authorized readers; removing IdS pointers corresponds to revocation of access rights from the IdS owner; extending the access control IdS with an empty block corresponds to retaining the data from everyone.

User-Sovereign Identity & Dynamic Identity Management

Even if the lookup of an identity is delegated to an identity provider (e.g. using CONIKS [13]) the identity creator holds the private keys and is both sovereign over the identity and responsible for each evolution. As long as the policy of the identity evolution is not breached by an adversary only the legitimate owner can change it.

Transparency

All actions are reads and writes and are provable against a public log (blockchain) and clients can verify that the proofs they see have been disclosed to the cothority, as the proofs bear the collective signature of the cothority, pro-actively mitigating targeted equivocation attacks [15].

Other Properties

Relationship Obfuscation: The writer can hide his relationship with any reader although transactions are publicly logged.

The writer generates an one-time key for the reader. No two obfuscated transactions will have the same policy and hence will be indistinguishable from other random obfuscated transactions. All properties mentioned above still hold for obfuscated transactions.

Secure Decentralized Identity Management: No user needs to rely on a trusted third party to follow the identity of another user.

Signed forward links provide decentralized trust delegation. Anyone can be convinced of the correct evolution of an identity (and hence the current valid keys) given a valid path from this secure reference pointer (assuming that the user bootstrapped correctly once).

Exemplary Applications

The inventors have successfully implemented embodiments of the invention using the programming language Go and tested exemplary applications:

Confidential Document Sharing and Access Control to Encrypted Documents

The first application comprises a decentralized document sharing application that enables an organization N to share a confidential document S with another organization A.

Organizations N and A agree on a mutually trusted cothority configuration. This cothority can include individual trustees controlled by N and A. In the example, we use a cothority of 4 servers (2 servers per organization). Each organization establishes a confidential federated IdS. The hashes of the IdS's genesis blocks are posted on the AC managed skipchain. Any key inside each chain is solely used for this chain to prevent linking of identities.

When Organization N generates document S each paragraph is labeled either confidential or unprotected. Afterwards N generates a write transaction for the confidential symmetric key including in the label of the transaction the respective IdS of A. The actual document S is encrypted under the symmetric key paragraph by paragraph and shared with organization A. Any authorized user of organization A can retrieve document S and create a proof-of-inclusion to the confidential IdS. This proof is attached to the read request and the cothority can atomically log it and deliver the encryption key. Organization A is free to evolve the confidential IdS as well as A's employees are free to evolve their individual IdSs.

Medical Research

Patient P has his medical data in multiple hospitals which refuse to share them because of potential privacy breaches. P, however, wants to grant access to a medical research team to use his data for their studies. Embodiments of the invention enable P to remain sovereign over his data. He can create an access identity that is published together with the encrypted form of his data. P can later update this policy skipchain (PolS) by including the identity of the medical research team. Afterwards, the research team can transparently access parts of the data and at the same time be held accountable in the case of abuse of the data.

Medical Data Sharing

An exemplary medical data sharing application based on an embodiment of the invention enables a sender Alice to share her data with multiple potential readers through time. A difference from the documents sharing application (see above) is that the data generator (hospitals) and the data owner (Alice) are different. For this reason, this example leverages the IdS data structure as a dynamically evolving indicator for Alice to the hospitals on how they should enable access on her data.

In this system the cothority is set-up with N servers supported by multiple hospitals, medical research teams, or health ministries. There is collective trust on the cothority that is reinforced by the transparent logging of its actions. When Alice gets a social security number, she initializes a federated IdS that will enable dynamic access control on her medical data. Every time she wants to share her data she 1) adds the identity or public key of the decryptor in her dynamic identity and 2) gives a pointer to her medical IdS to the potential reader, so that he can generate the appropriate inclusion proofs.

When new data are generated, the data creator (e.g. hospital) creates a new write transaction where the label is the medical IdS of Alice, the hospital stores the data in an encrypted form, but Alice is the sole entity that can authorize decryption requests, remaining sovereign over her medical data. Alice keeps privately a log of all these write transactions. She can point anyone she wants to them and at them in her medical identity, enabling them to access her data by issuing read transactions. This scheme might be further enhanced with payments towards Alice for sharing her data.

### REFERENCES

[1] BLAKLEY, G. R. Safeguarding cryptographic keys. Managing Requirements Knowledge, International Workshop on OO (1979), 313.
[2] CASTRO, M., AND LISKOV, B. Practical Byzantine Fault Tolerance. In 3rd USENIX Symposium on Operating Systems Design and Implementation (OSDI) (Feb. 1999).
[3] CHAUM, D., AND PEDERSEN, T. P. Wallet databases with observers. In IACR International Cryptology Conference (CRYPTO) (1992).
[4] FIAT, A., AND SHAMIR, A. How to prove yourself: practical solutions to identification and signature problems. In IACR International Cryptology Conference (CRYPTO) (1987), pp. 186-194.
[5] GENNARO, R., JARECKI, S., KRAWCZYK, H., AND RABIN, T. Secure distributed key generation for discrete-log based cryptosystems. In Eurocrypt (1999), vol. 99, Springer, pp. 295-310.
[6] HERZBERG, A., JARECKI, S., KRAWCZYK, H., AND YUNG, M. Proactive secret sharing or: How to cope with perpetual leakage. Advances in Cryptology CRYPT095 (1995), 339-352.
[7] JAKOBSSON, M. On quorum controlled asymmetric proxy re-encryption. In Public key cryptography (1999), Springer, pp. 632-632.
[8] KATE, A., HUANG, Y., AND GOLDBERG, I. Distributed key generation in the wild. In 29th International Conference on Distributed Computing Systems (2009).
[9] KOKORIS-KOGIAS, E., GASSER, L., KHOFFI, I., JOVANOVIC, P., GAILLY, N., AND FORD, B. Managing Identities Using Blockchains and CoSi. Tech. rep., 9th Workshop on Hot Topics in Privacy Enhancing Technologies (HotPETs 2016), 2016.
[10] KOKORIS-KOGIAS, E., JOVANOVIC, P., GAILLY, N., KHOFFI, I., GASSER, L., AND FORD, B. Enhancing Bitcoin Security and Performance with Strong Consistency via Collective Signing. In Proceedings of the 25th USENIX Conference on Secu-rity Symposium (2016).
[11] KOKORIS-KOGIAS, E., JOVANOVIC, P., GASSER, L., GAILLY, N., SYTA, E., AND FORD, B. OmniLedger: A Secure, Scale-Out, Decentralized Ledger via Sharding. Cryptology ePrint Archive, Report 2017/406, 2017.
[12] LAURIE, B. Certificate Transparency. ACM Queue 12, 8 (September 2014).
[13] MELARA, M. S., BLANKSTEIN, A., BONNEAU, J., FELTEN, E. W., AND FREEDMAN, M. J. CONIKS: Bringing Key Transparency to End Users. In Proceedings of the 24th USENIX Conference on Security Symposium (2015), USENIX Association, pp. 383-398.
[14] NAKAMOTO, S. Bitcoin: A Peer-to-Peer Electronic Cash System, 2008.
[15] NIKITIN, K., KOKORIS-KOGIAS, E., JO-VANOVIC, P., GAILLY, N., GASSER, L., KHOFFI, I., CAPPOS, J., AND FORD, B. CHAINIAC: Proactive Software-Update Transparency via Collectively Signed Skipchains and Verified Builds. In 26th USENIX Security Symposium (USENIX Security 17) (2017), USENIX Association, pp. 1271-1287.
[16] PILKINGTON, M. Blockchain technology: principles and applications. Browser Download This Paper (2015).
[17] SCHNORR, C. P. Efficient signature generation by smart cards. Journal of Cryptology 4, 3 (1991), 161-174.
[18] SCHOENMAKERS, B. A simple publicly verifiable secret sharing scheme and its application to electronic voting. In IACR International Cryptology Conference (CRYPTO) (1999), pp. 784-784.
[19] SCHOENMAKERS, B. A simple publicly verifiable secret sharing scheme and its application to electronic voting. Lecture Notes in Computer Science (1999), 148-164.
[20] SHAMIR, A. How to Share a Secret. Communications of the ACM 22, 11 (1979), 612-613.
[21] SHOUP, V., AND GENNARO, R. Securing threshold cryptosystems against chosen ciphertext attack. Advances in Cryptology EUROCRYPT'98 (1998), 1-16.
[22] SWAN, M. Blockchain: Blueprint for a new economy. “O'Reilly Media, Inc.”, 2015.
[23] SYTA, E., JOVANOVIC, P., KOKORIS-KOGIAS, E., GAILLY, N., GASSER, L., KHOFFI, I., FISCHER, M. J., AND FORD, B. Scalable Bias-Resistant Distributed Randomness. In 38th IEEE Symposium on Security and Privacy (May 2017).
[24] SYTA, E., TAMAS, I., VISHER, D., WOLINSKY, D. I., JOVANOVIC, P., GASSER, L., GAILLY, N., KHOFFI, I., AND FORD, B. Keeping Authorities “Honest or Bust” with Decentralized Witness Cosigning. In 37th IEEE Symposium on Security and Privacy (May 2016).
[25] THE OFFICE OF THE NATIONAL COORDINATOR FOR HEALTH INFORMATION TECHNOLOGY. Use of blockchain in health it and health-related research challenge, September 2016.
[26] YERMACK, D. Corporate governance and blockchains. Review of Finance 21,1 (2017), 7-31.

### Appendix A: Full Encryption/Decryption Protocol for LTS

Certain aspects of embodiments of the invention may be based on the protocol described in [21]. Consider a group G of prime order q with generators g and g̅. We assume the existence of two hash functions: H₁: G⁶×{0,0}^{l}→G and H₂:G³→ [symbol] _{q}.

A user that wants to encrypt a message under the collective public key X that can be decrypted by anyone included in label L∈{0,1}^{l} (later, this label may be the identifier of an Identity Blockchain) performs the following steps or a subset thereof:
1. Choose a key k to symmetrically encrypt the message and then embed k to a point m∈G.
2. Choose at random r,s∈ [symbol] g. Compute:

c=X^{r}m,u=g^{r},w=g^{s},ū=g̅^{r},w̅=g̅^{s},

e=H₁(c,u,ū,w,w̅,L),f=s+re

The ciphertext is (c, L, u, ū, e, f).

### Decryption Share Creation

Given a ciphertext (c, L, u, ū, e, f) and a matching authorization to L, a decryption server may perform the following steps or a subset thereof:
1. Check if e=H₁ (c, u, ū, w, w̅, L) where

$$w = \frac{{g}^{f}}{{u}^{e}} , \overline{w} = \frac{{\overline{g}}^{f}}{{\overline{u}}^{e}}$$

which is a NIZK proof that log_{g} u=log_{g̅} ū.
2. If the checks are valid, server i chooses sᵢ∈ [symbol] g at random, and computes:

uᵢ=u^{x}^{ᵢ},ûᵢ=u^{s}^{ᵢ},ĥᵢ=g^{s}^{ᵢ},

eᵢ=H₂(uᵢ,ûᵢ,ĥᵢ),fᵢ=sᵢ+xᵢeᵢ
3. Outputs (i, uᵢ, eᵢ, fᵢ).

Note that if the label L has changed, e is not computed correctly. Given that an adversary will not know r, he cannot change the e to match his new label.

Share Reconstruction at the Client
1. Share Verification: First the client runs the decryption share check to make sure that the server is not misbehaving. If the check passes then he checks that (u, uᵢ, hᵢ) is a DH triple, by checking if: eᵢ=H₂(uᵢ,ûᵢ,ĥᵢ), where

$${\hat{u}}_{i} = \frac{{u}^{{f}_{i}}}{{u}_{i}^{{e}_{i}}} , {\hat{h}}_{i} = \frac{{g}^{{f}_{i}}}{{h}_{i}^{{e}_{i}}}$$

2. Combining Shares: Assuming that the client has a set oft decryption shares (i,uᵢ) the recovery algorithm comprises doing Lagrange interpolation of the shares:

$${X}^{r} = {\prod }_{k = 0}^{t} {u}_{i}^{{λ}_{i}}$$

where λᵢ is the i^{th} Lagrange element.
3. Decrypt. The client computes the inverse of X^{r} and finds

$$m = \frac{c}{{X}^{r}} .$$

From m he can derive k and symmetrically decrypt the original message.

### Share Reconstruction at an Untrusted Server

The client authenticates himself using his public key g^{x}^{_{c}}. One of the decryption servers is assigned to do the reconstruction for the client.
1. ElGamal Encryption. Each Server that created his decryption share as g^{rx}^{ᵢ}=uᵢ ElGamal encrypts the share for the client using xᵢ as the blinding factor instead of a random r′. The new share looks like: g^{rx}^{ᵢ}g^{x}^{_{c}}^{x}^{ᵢ}=g^{(r+x}^{_{c}}^{)x}^{ᵢ}=g^{r′x}^{ᵢ}=u′^{x}^{ᵢ}=u′ᵢ. Then he computes ĥᵢ, as before and û′ᵢ=u′^{s}^{ᵢ}. Finally, e′ᵢ=H₂(u′ᵢ,û′ᵢ,ĥᵢ) and f′ᵢ=sᵢ+xᵢe′ᵢ.
2. Share combination. Any untrusted server can pool the shares and reconstruct the secret with Lagrange interpolation as shown above. The end result would be g^{r′x}=g^{(r+x}^{_{c}}^{)x}.
3. Secret decryption. The client gets g^{(r+x}^{_{c}}^{)x} and as he knows g^{x} and x_{c} he can find −x_{c} and compute g^{x}^{^{−x}}^{c}=g^{-xx}^{_{c}}. Finally he computes g^{rx}=g^{(r+x}^{_{c}}^{-x}^{_{c}}^{)x} and decrypts as above.

1.-70. (canceled)

71. A computer-implemented method for secure data exchange between a sender (A) and a recipient (B), wherein the method is performed by the sender (A) and comprises:
encrypting data using a symmetric key k;
creating a write transaction T_{W}, wherein the write transaction T_{W} comprises:
information usable to derive the symmetric key k; and
an access policy identifying the recipient (B) as being allowed to decrypt the encrypted data;
providing the recipient (B) access to the encrypted data; and
sending the write transaction T_{W} to a first group of servers (AC) for being stored in a blockchain data structure maintained by the first group of servers (AC).

72. The method of claim 71, wherein the first group of servers (AC) is different from the sender (A) and/or from the recipient (B).

73. The method of claim 71, wherein the sender (A) does not provide the symmetric key k to the recipient (B) and/or to the first group of servers (AC) and/or to any other computer system.

74. The method claim 71, further comprising:
generating a plurality of cryptographic secret shares using a cryptographic secret sharing procedure, in particular Publicly Verifiable Secret Sharing, PVSS, wherein the plurality of cryptographic secret shares is associated with a cryptographic secret; and
generating the symmetric key k based on the cryptographic secret;
wherein the information usable to derive the symmetric key k comprised in the write transaction T_{W} comprises the plurality of cryptographic secret shares.

75. The method of claim 71, wherein the write transaction T_{W} further comprises a signature of the sender (A) based on a private key x_{A} associated with the sender (A).

76. The method of claim 71, wherein the step of providing the recipient (B) access to the encrypted data comprises:
sending the encrypted data to the first group of servers (AC) for storage;
sending the encrypted data to the recipient (B); and/or
storing the encrypted data in a storage medium accessible to the recipient (B), in particular in a cloud storage and/or a distributed hash table, DHT.

77. The method of claim 71, wherein the access policy comprises a public key y_{B} associated with the recipient (B).

78. The method of claim 71, further comprising:
generating a temporary public key y′_{B} associated with the recipient (B);
wherein the access policy comprises the temporary public key y′_{B};
wherein the write transaction T_{W} further comprises information usable by the recipient (B) to calculate the temporary public key y′_{B}.

79. The method of claim 71, wherein the access policy further comprises:
a public key y_{B} associated with the recipient (B);
a unique identifier;
a version number;
at least one rule and/or an identifier of a blockchain data structure, preferably a skipchain data structure, associated with a public key y_{B} associated with the recipient (B).

80. A computer-implemented method for secure data exchange between a sender (A) and a recipient (B), wherein the method is performed by the recipient (B) and comprises:
retrieving encrypted data, wherein the encrypted data comprises data encrypted using a symmetric key k;
retrieving a write transaction T_{W} from a blockchain data structure maintained by a first group of servers (AC);
verifying the integrity of the write transaction T_{W}; and
if verifying the integrity of the write transaction T_{W} is successful, sending a read transaction T_{R} to the first group of servers (AC) for being stored in the blockchain data structure maintained by the first group of servers (AC).

81. The method of claim 80, wherein the step of retrieving the encrypted data comprises:
receiving the encrypted data from the sender (A);
retrieving the encrypted data from the first group of servers (AC); and/or
retrieving the encrypted data from a storage medium accessible to the recipient (B), in particular from a cloud storage and/or a distributed hash table, DHT.

82. The method of claim 80, wherein the step of verifying the integrity of the write transaction T_{W} comprises:
computing a hash of the encrypted data; and
determining whether the hash matches a hash H_{c} of the encrypted data comprised in the write transaction T_{W}.

83. The method of claim 80, wherein the read transaction T_{R} comprises:
a hash H_{W} of the write transaction T_{W}, and/or
a signature of the recipient (B) based on a private key x_{B} associated with the recipient (B).

84. The method of claim 80, wherein the write transaction T_{W} comprises an access policy identifying the recipient (B) as being allowed to decrypt the encrypted data.

85. The method of claim 80, further comprising:
receiving a cryptographic secret share associated with a cryptographic secret from each of a plurality of servers of a second group of servers (SC);
combining the cryptographic secret share to obtain the cryptographic secret;
computing the symmetric key k based on the cryptographic secret; and
decrypting the encrypted data using the symmetric key k.

86. The method of claim 80, further comprising:
sending a delegation request to a server; and
in response to the delegation request, receiving, from the server, information associated with a cryptographic secret usable for computing the symmetric key k.

87. The method of claim 80, further comprising:
creating a decryption request; and
sending the decryption request to a second group of servers (SC), wherein each server within the second group of servers (SC) stores a cryptographic secret share associated with a cryptographic secret which is usable by the recipient (B) to derive the symmetric key k;
wherein the decryption request comprises:
information identifying the write transaction T_{W};
information identifying the read transaction T_{R};
information identifying that the read transaction T_{R} is stored in the blockchain data structure maintained by the first group of servers (AC), wherein the information preferably comprises a signed header of a block that stores the read transaction T_{R} and/or a Merkle path πₘ; and/or
an aggregate public key of the first group of servers (AC) which maintains the blockchain data structure.

88. A computer-implemented method for secure data exchange between a sender (A) and a recipient (B), wherein the method is performed by at least one server within a first group of servers (AC) and comprises:
receiving a write transaction T_{W} from the sender (A), wherein the write transaction T_{W} comprises:
information usable to derive a symmetric key k;
verifying the integrity of the information; and
if verifying the integrity of the information is successful, storing the write transaction T_{W} in a blockchain data structure maintained by the first group of servers (AC).

89. The method of claim 88, wherein:
the step of receiving the write transaction T_{W} comprises receiving a decryption request DecReq from the recipient (B), wherein the decryption request DecReq comprises the write transaction T_{W} and a corresponding read transaction T_{R};
the step of verifying the integrity of the information comprises verifying the integrity of the read transaction T_{R}; and
the step of storing the write transaction T_{W} in the blockchain data structure comprises computing a decrypted share based on an encrypted cryptographic secret share associated with a cryptographic secret which is usable by the recipient (B) to derive a symmetric key k, wherein the encrypted cryptographic secret share is comprised in the write transaction T_{W}, and sending the decrypted share to the recipient (B).

90. The method of claim 88, wherein the information usable to derive the symmetric key k comprises a plurality of cryptographic secret shares;
wherein the write transaction T_{W} further comprises:
a plurality of encryption consistency proofs πₑ, in particular Non-Interactive Zero-Knowledge, NIZK, proofs, corresponding to the plurality of cryptographic secret shares;
a plurality of polynomial commitments cⱼ; and/or
a public key yᵢ associated with each server of a second group of servers (SC);
wherein verifying the integrity of the information comprises verifying the integrity of each cryptographic secret share based on the corresponding encryption consistency proof πₑ, the corresponding polynomial commitment cⱼ, and/or the corresponding public key yᵢ.
